(19) United States
(12) Patent Application Publication
(10) Pub. No.: US 2006/0157112 A1
(43) Pub. Date: Jul. 20, 2006

(54) Railcar transfer containment unit

(76) Inventors: Jack G. Brewer, Chickasha, OK (US); Steven L. Shroyer, Norman, OK (US); Darrel B. Fruit, Mustang, OK (US); Darrel G. Fruit, Chickasha, OK (US)

Correspondence Address: JAMES T. ROBINSON, 222 E. MAIN STREET, NORMAN, OK, 73069, US

(21) Appl. No.: 11/040,841

(22) Filed: Jan. 19, 2005

(51) Int. Cl. G05D 7/00

(52) U.S. Cl. 137/312

(57) ABSTRACT

A railcar transfer containment unit for collecting spillage during transfer of liquid from a railcar tanker provides a container, a vertically adjustable ell disposed within the container, means for adjusting the vertical position of the ell within the container, and means for locking the ell in a selected fixed vertical position. Conductive grounding straps reduce the danger of fire resulting from a static electricity discharge during transfer of flammable liquids.

### BACKGROUND OF THE INVENTION

The present invention relates generally to containment of spills, and more particularly, but not by way of limitation, to an apparatus for containing spillage during transfer of liquid contents to or from tank cars used for hauling liquids by rail. As used herein, the term “rail car tanker,” “railcar tanker,” or “railcar” will be used interchangeably to mean a tanker type car used for hauling liquids by rail.

Transfer of a liquid from a railcar tanker frequently results in leakage of the liquid at the line coupling. The liquid is also prone to spill from the ends of transfer lines as the transfer lines are being connected and disconnected. The liquid may be a hydrocarbon or other petrochemical which contaminates the surrounding environment and necessitates remedial action. The liquid may also be a food product such as corn syrup whose presence is, at the very least, a nuisance.

Between loads, the railcar tankers must be cleaned to prevent cross-contamination between different contents. Rail cars are often cleaned using high pressure water jetting equipment. Water jetting equipment, which is inserted into the rail car, shoots streams of cleansing water jets under high pressure to all areas of the rail car interior. The water-liquid mixture must then be removed through a line connection attached to the rail car.

A typical railcar tanker includes a line connection at the lowest point in the tanker. The tanker line connection is generally centered between the two rails on which the railcar travels above the crossties and surrounding fill. The height of the tanker line connection above the crossties varies. From time to time, operators have attempted to catch any spillage by placing a reservoir beneath the line connection. Those efforts have been ineffective, however, in part because the liquid tends to follow the liquid transfer lines and in part because the non-standard height of the tanker line connection requires different apparatus for different tanker car configurations.

Hence, there is a need for a simple, economical and effective apparatus for containing spillage from a line connection wherein the apparatus is easily adaptable for varying heights of the tanker line connection above the crossties.

### SUMMARY OF THE INVENTION

A railcar transfer containment unit for collecting spillage during transfer of liquid from a railcar tanker having a bottom line connection provides a container, a vertically adjustable ell disposed within the container, means for adjusting the vertical position of the ell within the container, and means for locking the ell in a selected fixed vertical position. Conductive grounding straps are provided to reduce the danger of fire resulting from a static electricity discharge during transfer of flammable liquids.

An object of the present invention is to provide an easily deployed spill containment unit adaptable for railroad tanker cars of varying heights.

Another object of the present invention is to provide a spill containment unit which will securely store fixed-length quick-coupling connection line assembly within the container.

Yet another object of the present invention is to provide a spill containment unit which can be cleaned out using the same transfer pump utilized to pump the liquid from the railcar to another storage location.

Other objects, features, and advantages of the present invention will become clear from the following description of the preferred embodiment when read in conjunction with the accompanying drawings and appended claims.

### BRIEF DESCRIPTION OF THE DRAWINGS

FIG. 1 is a view of applicant's railcar transfer containment unit located beneath a line connection of a railcar tanker.

FIG. 2 is a cross-sectional view of the railcar transfer containment unit shown in FIG. 1.

FIG. 3 is a cross-sectional exploded view of another railcar transfer containment unit according to applicant's invention.

FIG. 4 is an enlarged detail view of a portion of the railcar transfer containment unit shown in FIG. 3.

FIG. 5 is another view of the railcar transfer containment unit shown in FIG. 3 wherein the railcar transfer containment unit is shown in a relatively lower position to accommodate a relatively lower railcar line connection.

FIG. 6 is another view of the railcar transfer containment unit shown in FIG. 3 wherein the railcar transfer containment unit is shown in a relatively higher position to accommodate a relatively higher railcar line connection.

FIG. 7 is an enlarged detail view of a portion of the railcar transfer containment unit shown in FIG. 2.

FIG. 8 is a cross-sectional view of another railcar transfer containment unit according to applicant's invention.

FIG. 9 is another view of the railcar transfer containment unit shown in FIG. 2.

FIG. 10 is another view of the railcar transfer containment unit shown in FIG. 2.

FIG. 11 is plan view of the railcar transfer containment unit shown in FIG. 2.

FIG. 12 is a view of another railcar transfer containment unit according to applicant's invention.

### DETAILED DESCRIPTION OF THE INVENTION

In the following description of the invention, like numerals and characters designate like elements throughout the figures of the drawings.

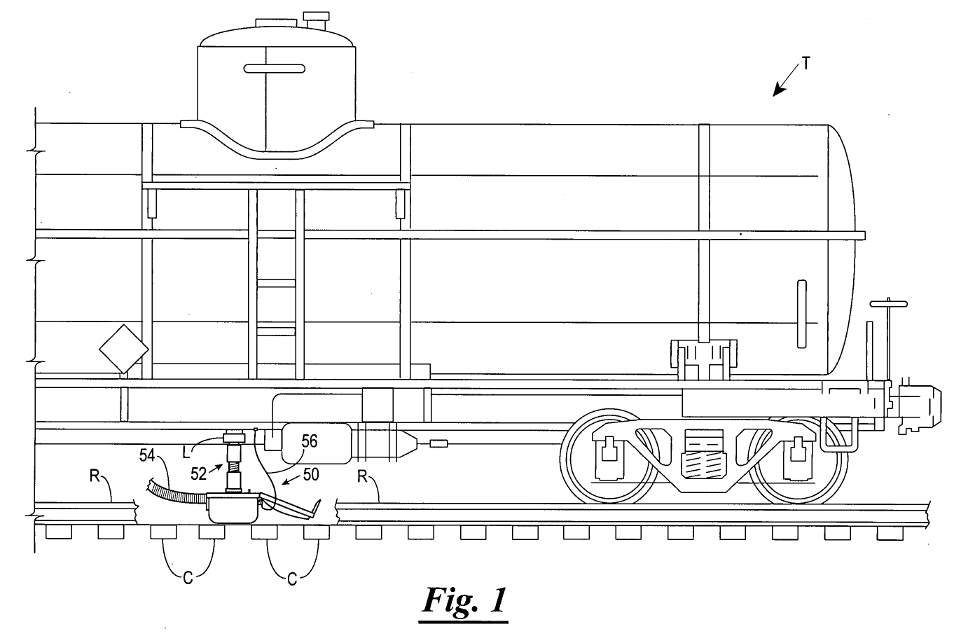

Referring generally to the drawings and more particularly to FIGS. 1, a railcar transfer containment unit 50 is connected to a line connection L of a railcar tanker T. A railcar line connection valve (not shown) is normally closed unless liquid is being transferred from the railcar tanker T. The railcar transfer containment unit 50 is supported by crossties C between the rails R (only one rail shown). A vertical connection line assembly 52 connects the railcar transfer containment unit 50 to the line connection L of the railcar tanker T. A transfer line 54 connected to the railcar transfer containment unit provides a conduit for flow of the liquid contents of the railcar tanker T to a pump (not shown) or other storage (not shown). An external grounding strap 56 connects the railcar transfer containment unit 50 to the railcar tanker T.

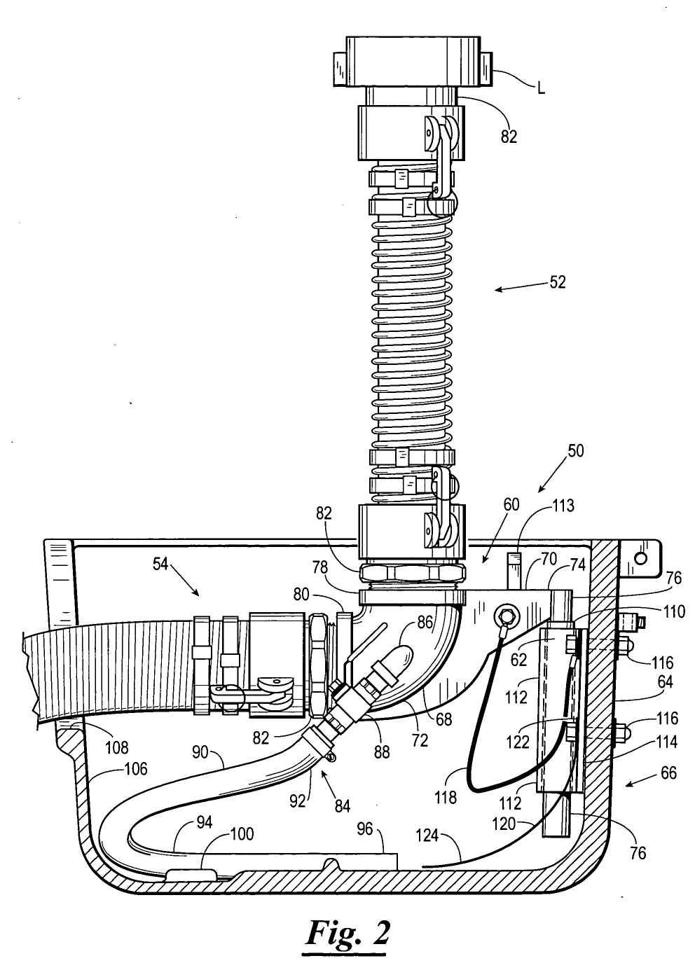

Referring now to FIGS. 2 and 3, the railcar transfer containment unit 50 is shown in cutaway. An ell assembly 60 is mounted in a support assembly 62 attached to a rear wall 64 of a container 66. The ell assembly 60 includes a standard ell (i.e., a 90-degree pipe fitting) 68 held in fixed position by an ell support member 70. The ell support member 70 has an arcuate end 72 proximate to the ell 68 and a distal end 74 attached to a vertical slide 76 retained by the support assembly 62.

Still referring to FIGS. 2 and 3, the ell 68 includes a top opening 78 and a side opening 80. The top opening 78 is coupled to one end of the vertical connection line assembly 52, and the side opening 80 is attached to one end of the transfer line assembly 54. Quick-coupling fittings 82 attached to the railcar line connect L, the top opening 78, and the side opening 80 facilitate deployment of the railcar transfer containment unit 50.

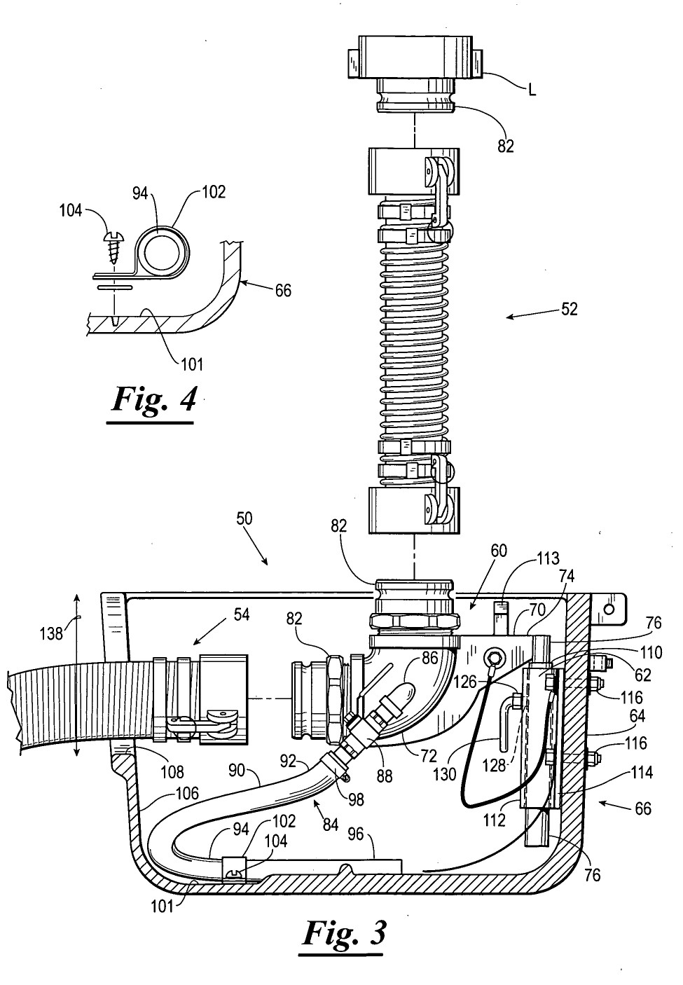

Referring now to FIGS. 2-4, a container cleanout assembly 84 is attached to the ell 68. The container cleanout assembly 84 includes, in order moving away from the ell 68, a pipe fitting 86, a valve 88, and a flexible hose 90 having an upper end portion 92, an intermediate portion 94, and a lower end portion 96. A hose clamp 98 secures the upper end portion 92 to one port of the valve 88. In FIG. 2, a puddle of adhesive 100 secures the intermediate portion 94 of the flexible hose 90 to the bottom of the container 66. In FIG. 3, a clamp 102 held in place by a screw 104 secures the intermediate portion 94 of the flexible hose 90 to the bottom of the container 66. It will be understood by one skilled in the art that the puddle of adhesive 100 and the clamp 102 merely serve as an anchor to ensure the lower end portion 96 of the flexible hose 90 rests at a low point in the container 66.

Referring now to FIGS. 2-3, the container 66 has a front wall 106 opposite the rear wall 64. A cutout 108 in the front wall 106 provides a passageway for the transfer line assembly 54.

With the railcar line connection valve in the closed position, the railcar transfer containment unit 50 to the line connection L of the railcar tanker T using the vertical connection assembly 52 and to a transfer pump using the transfer line assembly 54. The valve 88 in the container cleanout assembly 84 is closed and the railcar line connection is open, permitting unimpeded flow from the railcar tanker T downwardly through the vertical connection assembly 52, through the ell 86, and out the transfer line assembly 54 to the transfer pump or, in the alternative, to another tank. Any spillage, which may take the form of a few drops or a small stream, are collected within the container 66. When the transfer is complete, the railcar line connection valve is once again closed and the valve 88 in the container cleanout assembly 84 is opened. Operation of the transfer pump will now remove any spillage from the container 66.

Referring now to FIG. 2, the support assembly 62 includes a non-metallic cylindrical sleeve 110 fixed within a cylindrical housing 112. The vertical slide 76 is biasedly received by the non-metallic cylindrical sleeve 110. A handle 112 attached to ell support member 70 facilitates adjustment of the vertical slide 76 within the non-metallic cylindrical sleeve 110 to adapt to varying distances between the railcar line connection L and the crossties C. The vertical slide 76 is held in position within the support assembly 62 by frictional bias. The cylindrical housing 112 is affixed to a support plate 114 attached to the rear wall 64 of the container 66 by fastener assemblies 116 (nuts and bolts).

Referring now to FIGS. 2-3, an ell assembly grounding cable 118 connects the ell support member 70 to the fastener assembly 116. A fluid grounding strap 120 has an upper end portion 122 attached to a fastener assembly 116 and a lower end portion 124 resting generally against the bottom 101 of the container 66.

Referring now to FIG. 3, a threaded nut 126 covering a threaded hole 128 in the cylindrical housing 112 receives a locking handle 130. The locking handle 130 can be tightened against the cylindrical sleeve 110 to further restrict movement of the slide 76 within the support assembly 62.

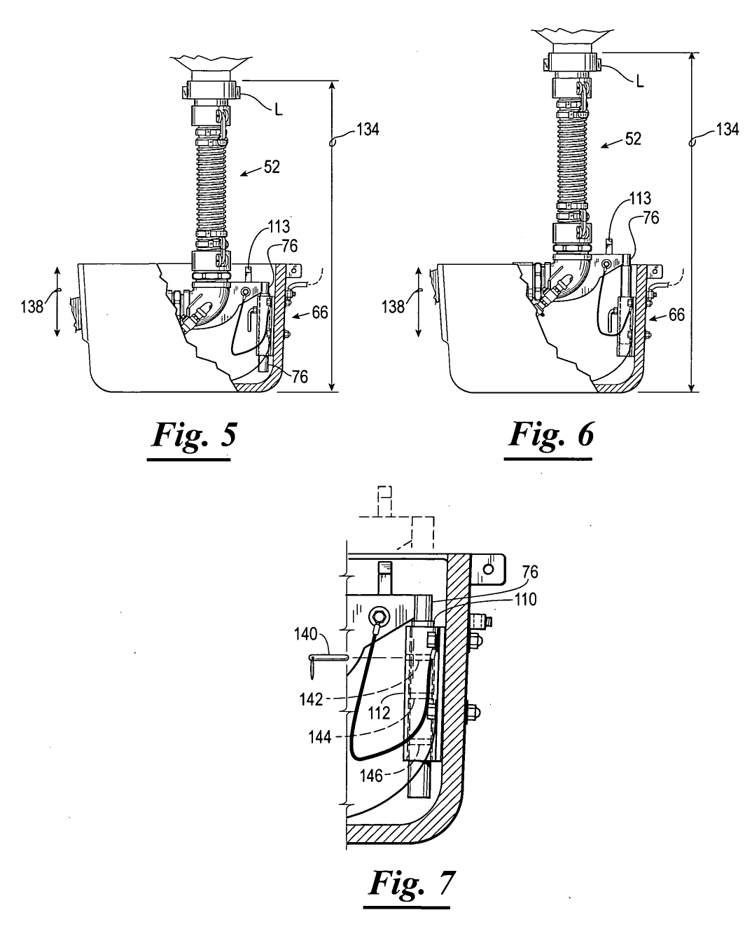

Referring now to FIGS. 5 and 6, the movement of the slide 76 is illustrated. In FIG. 5, the ell assembly 60 is in a lowered position to adapt to a distance 134 between the railcar line connection L and the crossties (see FIG. 1). In FIG. 6, the ell assembly 60 is shown in a raised position to adapt to a greater distance 136 between the railcar line connection L and the crossties (see FIG. 1).

Still referring to FIGS. 5-6, adjustability of the vertical position of the ell assembly 60 is required for varying railcar tanker configurations. The container 66, deployed beneath the railcar line connection L of the railcar tanker T, must be in a proper position to collect spillage. The flexible hose 90 of the container cleanout assembly 84, the ell assembly grounding cable 118, and the fluid grounding strap 120 are of sufficient length to accommodate the change in vertical position of the ell assembly 60. Similarly, the cutout 108 in the front wall 106 of the container 66 permits movement of the transfer line assembly 54 along arrow 138 as the ell assembly 60 moves between the relatively lower vertical position shown in FIG. 5 and the relatively higher vertical position shown in FIG. 6.

Referring now to FIG. 7, another mechanism for locking the slide 76 in a selected vertical position provides a pull pin 140 which can be inserted in an upper slot 142, an intermediate slot 144, or a lower slot 146 in the support 62.

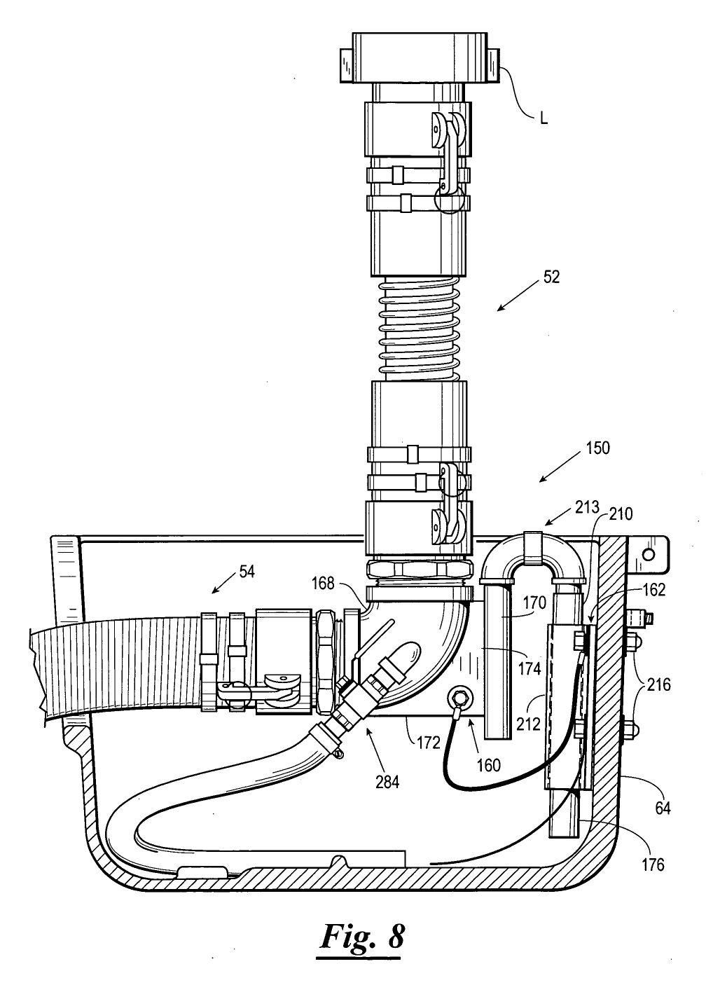

Referring now to FIG. 8, another railcar transfer containment unit 150 includes an ell assembly 160 mounted in a support assembly 162 attached to a rear wall 64 of a container 66. The ell assembly 160 includes a standard ell (i.e., a 90-degree pipe fitting) 168 held in fixed position by an ell support member 170. The ell support member 170 has an arcuate end 172 proximate to the ell 168 and a distal end 174 attached to a candy-cane shaped handle 213. The candy-cane shaped handle 213 is attached at the short end to a vertical slide 176 retained by the support assembly 162. In all other respects, the railcar transfer containment unit 150 shown in FIG. 8 is like the railcar transfer containment unit 50 shown in FIG. 2.

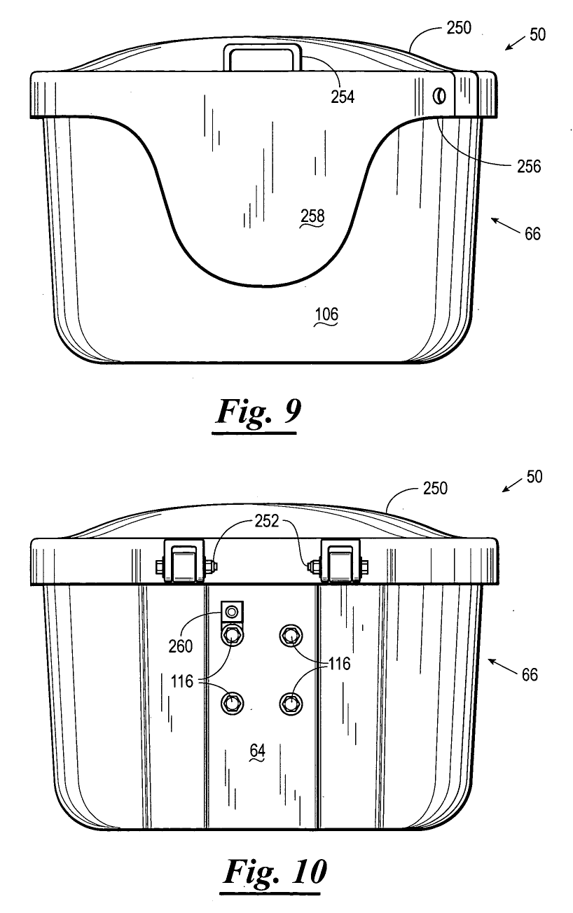

Referring now to FIGS. 9-10, the container 66 has a cover 250 attached to the container 66 by hinge assemblies 252. The cover 250 has a handle 254, a locking ear 256, and a downwardly projecting member 258 covering the cutout 108 (see FIGS. 2-3) when the railcar transfer containment unit 50 is not in use. A grounding lug 260 attached to one of the fasteners 116 provides a connection for the external grounding strap 56 (see FIG. 1).

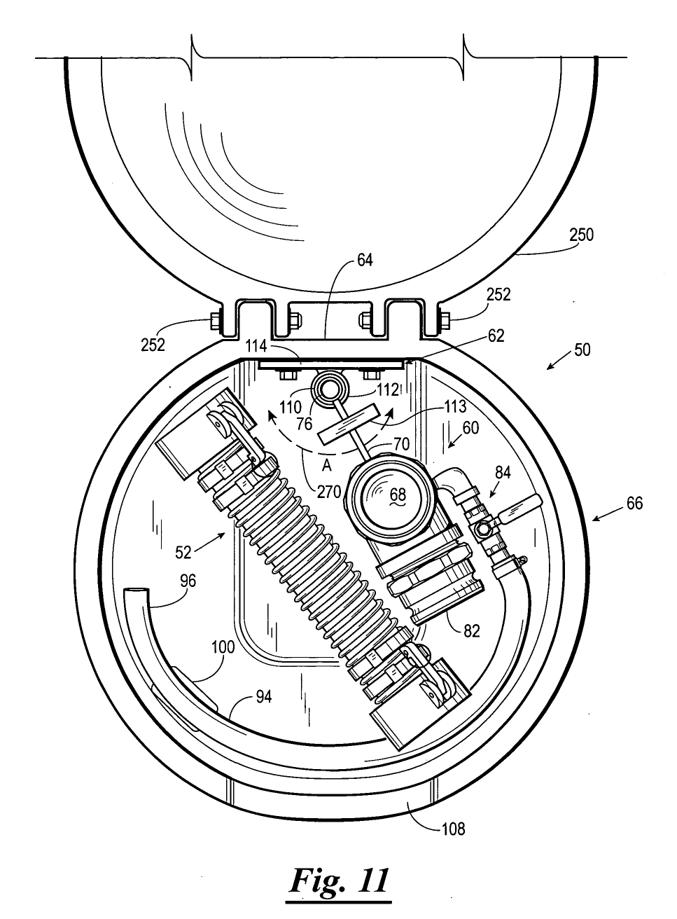

Referring now to FIG. 11, the railcar transfer containment unit 50 shown in FIG. 2 is shown in plan view. For simplicity, not all parts are shown. The arrow A shows how the ell assembly 60 can swing as the slide 76 rotates within the cylindrical housing 112 and the non-metallic sleeve 110. When the ell assembly 60 is moved to an extreme position, the vertical connection line assembly 52 is conveniently stored within the container 66.

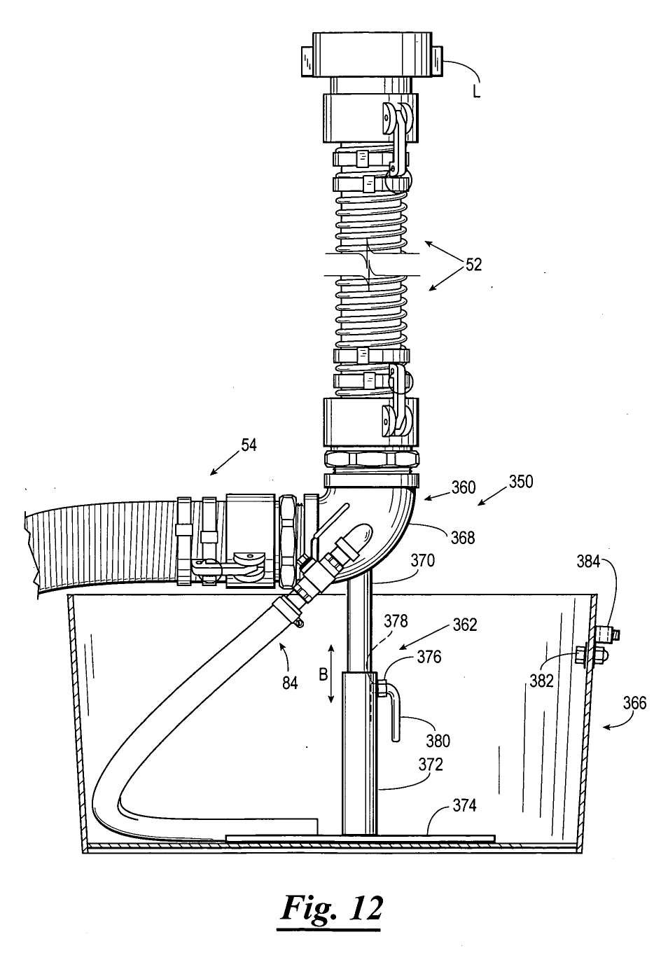

Referring now to FIG. 12, another railcar transfer containment unit 350 is shown. A vertically adjustable ell assembly 360 is supported by a telescoping stand 362 disposed within a container 366. The ell assembly 360 includes a standard ell (i.e., a 90-degree pipe fitting) 368 held in fixed position by an elongated ell support member 370. The elongated ell support member 370 is slidably received within a vertical member 372 supported by a base plate 374. The elongated ell support member 370 is vertically adjustable along arrow B to adapt to different heights of the railcar tanker line connection L above the crossties C (see FIG. 1). A threaded nut 376 covering a threaded hole 378 in the vertical member 372 receives a locking handle 380. The locking handle 380 can be tightened against the elongated ell support member 370 to lock the ell assembly 360 in a selected vertical position. The vertical connection line assembly 52, the transfer line assembly 54, and the container cleanout assembly 84 were described in detail above. An internal grounding terminal 382 in a wall of the container 366 is conductively connected to an external grounding lug 384. If appropriate, internal grounding straps can be attached to the internal grounding terminal 382 and an external grounding strap 56 (see FIG. 1) can be used to connect the external grounding lug 384 to an appropriate location on the railcar tanker T.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A railcar transfer containment unit for collecting spillage during transfer of liquid from a railcar tanker having a bottom line connection, wherein a fixed-length quick-coupling vertical connection line assembly attaches to the tanker line connection and a quick-coupling transfer line assembly attaches to a pump to effect the transfer, the railcar transfer containment unit comprising:
a container;
an ell disposed within the container, the ell adapted to receive the fixed-length quick-coupling vertical connection line assembly at the top and the quick-coupling transfer line assembly at the side;
means for adjusting the vertical position of the ell within the container, so that the container rests on the ties beneath the railcar tanker line connection, and the ell cooperates with the fixed-length quick-coupling vertical connection line and the quick-coupling transfer line assembly to form a continuous fluid path for removal of liquid from the railcar tanker; and
means for locking the ell in a selected fixed vertical position.

2. The device of claim 1 wherein a cleanout assembly is attached to the ell for cleaning spillage from the container when liquid transfer is complete, the cleanout assembly comprising:
a pipe fitting attached to the ell;
a flexible hose having an upper end portion, an intermediate portion, and a lower end portion; and
a cleanout valve connecting the pipe fitting to the upper end portion of the flexible hose and the lower end of the flexible hose rests against the bottom of the container, so that, after liquid transfer is complete, the cleanout valve can be opened and the transfer pump can be used to remove accumulated spillage from the container.

3. The device of claim 2, further comprising grounding means for conductively connecting the ell, the adjusting means, the locking means, and the liquid to the railcar.

4. The device of claim 3, wherein said grounding means comprises:
an internal grounding terminal located inside the container;
an external grounding lug located outside the container and conductively connected to the internal grounding terminal;
an ell grounding cable for conductively connecting the ell to the internal grounding terminal;
a fluid grounding strap for conductively connecting fluid collected within the container to the internal grounding terminal; and
an external grounding strap for conductively connecting the external grounding lug an the railroad tanker car.

5. The device of claim 1, wherein the ell is attached to a vertically adjustable slide disposed within a non-metallic cylindrical sleeve, the sleeve being disposed within a cylindrical housing attached to a side wall of the container, so that force applied to the vertically adjustable slide effects vertical movement of the slide within the non-metallic cylindrical sleeve and wherein frictional bias between the vertically adjustable slide and the non-metallic cylindrical sleeve locks the ell in fixed vertical position in the absence of an applied force.

6. The device of claim 5, wherein the cylindrical housing has a threaded bore, a threaded nut is welded over the threaded bore in the cylindrical housing, and a threaded bolt extends through the threaded nut and the threaded bore to rest against the non-metallic cylindrical sleeve, so that tightening of the threaded bolt creates additional frictional bias against the non-metallic cylindrical sleeve and the vertically adjustable slide disposed therein.

7. The device of claim 6, wherein the vertically adjustable slide rotates within the housing so that the ell swings horizontally within the container.

8. The device of claim 1, wherein said means for adjusting the vertical position of the ell within the container further comprises:
a horizontal base plate disposed within the container;
a fixed vertical member extending upwardly from the base plate;
a telescoping vertical member extending upwardly from the fixed vertical member, the telescoping vertical member having a lower end slidably received within the fixed vertical member and an upper end affixed to the ell so that movement of the telescoping vertical member within the fixed vertical member adjusts the vertical position of the ell; and
means for locking the telescoping vertical member within the fixed vertical member.
